(19) United States
(12) Patent Application Publication
(10) Pub. No.: US 2006/0005412 A1
(43) Pub. Date: Jan. 12, 2006

(54) Applique pattern kit

(76) Inventor: Bridget Ellen Frawley, Camberwell (AU)

Correspondence Address: ARMSTRONG, KRATZ, QUINTOS, HANSON & BROOKS, LLP;Intellectual Property Law Offices, Suite 220, 502 Washington Avenue, Towson, MD, 21204, US

(21) Appl. No.: 11/177,005

(22) Filed: Jul. 8, 2005

(30) Foreign Application Priority Data
Jul. 9, 2004 (AU) 2004100555

(51) Int. Cl. B43L 7/00

(52) U.S. Cl. 33/566

(57) ABSTRACT

An applique pattern kit including a plurality of templates bearing identifying indicia and which can be arranged to correspond to a desired completed design, said templates being removably located on a support member, said support member having a location guide to assist in locating said templates in position on the support member.

### BACKGROUND OF THE INVENTION

This present invention relates to an applique pattern kit and a method of making an applique.

Applique involves laying and attaching one piece of fabric over another to create a decorative design. The pieces of fabric may be attached in several ways, by hand or by machine. In one method blanket stitch or machine zig zag stich is used around the edges of an applique motif to enhance the design and to cover raw edges and therefore no seam allowances may be needed. In another method, the motif is traced onto paper with no seam allowances. The fabric is then cut out allowing for a 5 mm (¼″) seam allowance. The seams are turned under and then stitched.

Applique patterns are often sold as kits, typically in which the fabric is provided along with a piece of paper on which each of the templates which are used to cut the individual motifs are drawn. The user is required to either cut out the templates from the paper or alternatively trace the templates which are then cut out. It is often necessary to enlarge templates which can either be done with a pantograph or a photocopier.

Once the pattern has been optionally enlarged and traced it may be necessary to mark out the applique design on the backing fabric prior to cutting. Methods include taping the design to a light box, well lit window or glass top table with a lamp underneath. Using masking tape the fabric is taped on top of the design and the design is marked on to the fabric with pencil or a water erasable marker. Individual templates may be drawn around with pencil or a water erasable marker.

Tracing, enlarging, and cutting out the individual templates is time consuming and many users would prefer to omit this step and proceed with the applique sewing steps.

It is an object of the present invention to address one or more of the aforementioned disadvantages, or at least, to provide a useful alternative thereto.

### SUMMARY OF THE INVENTION

According to the present invention there is provided an applique pattern kit including a plurality of templates bearing identifying indicia and which can be arranged to correspond to a desired completed design, said templates being removably located on a support member, said support member having a location guide to assist in locating said templates in position on the support member.

According to a further embodiment of the present invention, there is provided an applique pattern kit, including a plurality of templates that together bear the design of a completed applique item, said templates being removably located on a support member, said support member bearing the outline of each template to provide a location guide for replacing said templates.

According to a further embodiment of the present invention there is provided a method of making an applique including the steps of:

providing a backing fabric;

providing a plurality of templates bearing identifying indicia and which can be arranged to correspond to a desired completed design, said templates being removably located on a support member, said support member having a location guide to assist in locating said templates in position on the support member;

removing the templates from the support member;

tracing a line around each template onto desired fabrics to give an outline of each template;

cutting around each outline optionally allowing a seam allowance to give pieces of fabric; and

attaching each piece of fabric to the backing fabric to create the desired completed design.

According to another embodiment of the present invention, there is provided a method of making an applique including the steps of:

providing a backing fabric;

providing a plurality of templates that together bear the design of a completed applique item, said templates being removably located on a support member, said support member bearing the outline of each template to provide a location guide for replacing said templates;

removing the templates from the support member;

tracing a line around each template onto desired fabrics to give an outline of each template;

cutting around each outline optionally allowing a seam allowance to give pieces of fabric; and

attaching each piece of fabric to the backing fabric to create the desired completed design.

The present invention is directed towards an applique pattern kit where the user is provided with pre-cut templates which are ready to use. Together the templates form a desired design such as a house, flower, bird etc. The applique pattern kit of the present invention avoids the need for tracing, enlarging and cutting out individual templates.

It is preferred that the templates be formed from a relatively rigid material and which is of a thickness which may be easily traced around. Cardboard or certain relatively stiff plastic materials are suitable. In a preferred embodiment of the invention the templates are formed from cardboard.

The templates bear identifying insignia which allow the user to arrange them into the desired completed design. The identifying insignia may consist of, for example, numbers, letters, colours or even a picture of the desired completed design. The insignia assists the user in ensuring that they cut the correct number of pieces and assists the user in locating the pieces when sewing the applique. The insignia may also be used to assist in replacement of the pieces into position on the support member.

In a preferred embodiment the templates are joined together prior to use, but are easily separated by the user. For example cardboard patterns may be provided with perforations and plastic patterns with perforations or lines of weakness which allows easy separation by the user.

The pieces are removably located on a support member. The support member carries a location guide to assist in locating the templates. The location guide may consist of markings matching the outlines of the pattern pieces. These markings may either be printed on the support member or may consist of a slight indentation in the support member corresponding to the outlines of the pattern pieces. The support member may bear indicia corresponding to that of the templates to assist in easy location and the replacement of the templates after use. In a preferred embodiment the templates are located on the support member in an arrangement corresponding to the completed applique design.

The support member is preferably constructed of a material which is stiff so that the applique pattern kit can be conveniently stored. The support member may also be formed from plastic or cardboard and in a preferred embodiment of the invention is formed from cardboard.

The support member may also bear the design of the completed applique item. The precut templates and the support member may bear the same design, so enabling the user to easily replace the templates onto the support member after use.

It is preferred that the support member has template retaining means. Template retaining means will assist in preventing the templates from moving once the templates are located on the support member. In a preferred embodiment the template retaining means comprises a raised border around the periphery of the support member which abuts the templates. This assists in preventing the templates from sliding off the support member and provided that the support member is carried and stored in a relatively horizontal position will allow the templates to be retained on the support member in their correct positions. The raised border may be relatively wide in parts depending on the shape of the desired completed design. In some designs two pieces of fabric may be required to be sewn one on top of the other. In this case one template usually the template corresponding to the piece that is to be sewn on top, may be located on an area within the waste portion of the template support member.

In a preferred embodiment the templates are all interfitting and so fit together in a similar fashion to a jigsaw puzzle. In some applique designs the templates will not be interfitting. The location guides may include raised areas on the support member which abut the templates in order to assist in locating and retaining the templates on the support member.

In use a template is removed from the support member, placed onto the fabric to be cut, the user traces around the template, and replaces the template. The user then cuts around the traced outline of the template allowing a seam allowance if desired. The user may then complete the applique process by attaching the cut pieces of fabric to a backing fabric by any known means.

The applique pattern of the present invention may be used for both machine and hand applique methods.

The kit will preferably be presented in a plastic sleeve which allows for convenient storage. If the sleeve is snug fitting, it advantageously allows the kit to be stored in a position other than relatively horizontal without the templates moving from their individual locations on the support member.

The applique pattern kit may also optionally include an instruction sheet or booklet, a pattern layout diagram, fabric, thread and other items such as buttons which are needed to complete the applique. An example of an instruction sheet is provided at Example 1.

An applique pattern kit generally includes one individual design. The kit may be sold as a book of kits or several kits may be sold together, for example, to construct a quilt made by piecing together applique designs made from a number of kits, for example 12 or 16.

### BRIEF DESCRIPTION OF THE DRAWINGS

The following is a brief description of the preferred embodiments with reference to the accompanying drawings. It is to be understood that the features illustrated in and described with reference to the drawings are not to be construed as limiting on the scope of the invention In the drawings:

FIG. 1 is a plan view of a support member of an applique pattern kit of the present invention.

FIG. 2 is a plan view of an applique pattern kit according to one embodiment of the present invention.

FIGS. 3 to 7 are plan views of quilts made from appliques made by the method of the present invention.

### DESCRIPTION OF THE PREFERRED EMBODIMENTS

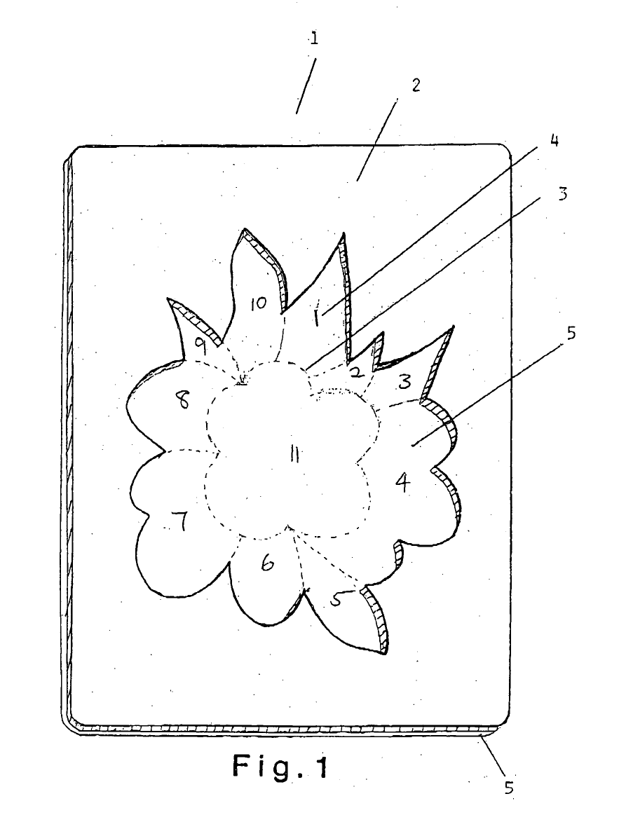

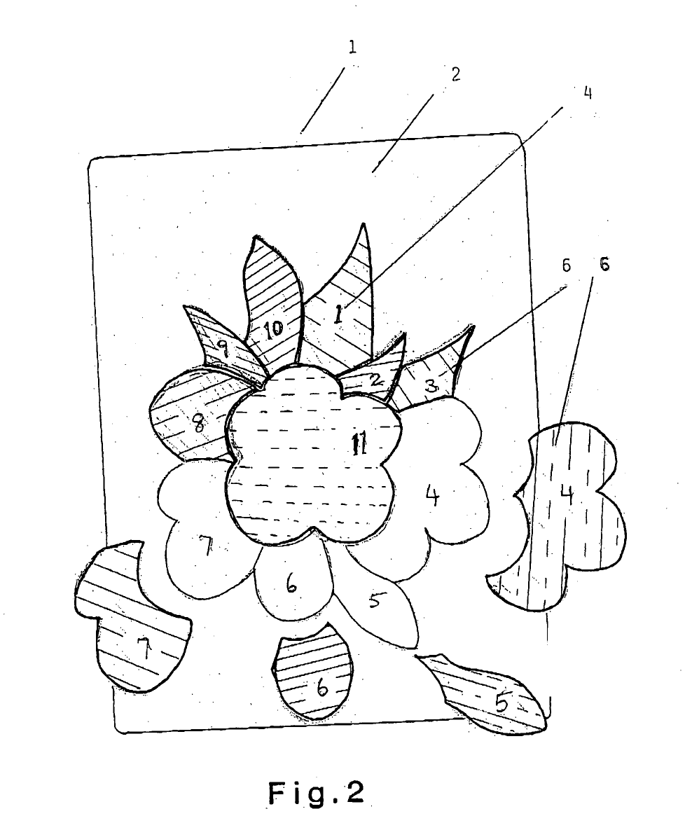

In FIG. 1 is shown a support member 1 of an applique pattern kit of the present invention. Support member 1 includes template retaining means 2 which is a raised border around a periphery of the support member which extends to the edges of the area where the templates 6 shown in FIG. 2 sit. Template retaining means is formed from cardboard, glued to the base 5 of the support member. Base 5 is also formed from cardboard. Support member 1 includes a location guide 3 which consists of lines corresponding to the outline of each template marked on to support member 1. Support member also bears indicia 4 corresponding to the indicia on the corresponding templates 6 shown in FIG. 2.

In FIG. 2 is shown a plan view of an applique pattern kit according to one embodiment of the invention There is shown a support member 1 and template retaining means 2. The hatched areas correspond to templates 6 which bear identifying indicia 4 corresponding to the indicia marked on support member 1. It can be seen that templates 6 can be removed from the support member for use in the applique method and then replaced after use using the location guide 3 as a guide for replacing the templates. The kit may be then conveniently stored in a plastic sleeve for further use.

### EXAMPLE 1

### Instructions

Machine Sewing

1. Cut out backing fabric squares at 38 cm×38 cm (15″×15″).

2. Using the pattern layout, trace design onto selected backing fabric. A light table or a bright window is best for tracing through onto fabric.

3. If bias binding is required make enough to cover all binding areas. To make bias binding cut strips of fabric on the bias twice the width of the finished size (e.g. if the bias binding is 1 cm wide, cut the strips 2 cm iron outside edges into centre at the back). Bias folders can be used to make this process easier.

4. Attach bias binding to backing fabric using a satin stitch or a small tight zigzag stitch.

5. Iron double sided fusing to the back of printed fabrics.

6. Cut out each piece and iron onto backing fabric as per design.

7. Sew each piece around the edge using small tight zigzag stitch or satin stitch so that fabric is attached. This can be done as each piece is ironed on or alternatively a few pieces can be done at a time. It is recommended to work on a section at a time.

8. Machine or hand embroider on applique as required.

9. Embellish further if required.

Hand Sewing

1. Cut out backing fabric squares at 38 cm×38 cm (15″×15″).

2. Using the pattern layout, trace design onto selected backing fabric. A light table or a bright window is best for tracing through onto fabric.

3. If bias binding is required make enough to cover all binding areas. To make bias binding cut strips of fabric on the bias twice the width of the finished size (e.g. if the bias binding is 1 cm wide, cut the strips 2 cm iron outside edges into centre at the back). Bias folders can be used to make this process easier.

4. Cut pattern pieces out, ensure that each piece has an additional 5 mm (¼″) seam allowance. Pin into place and attach using a tiny slip stitch, if an edge is to be covered by another piece tacking down flat will be sufficient (see diagram).

5. Continue step 4 until all pieces are attached.

6. Hand embroider as required.

7. Embellish further if required.

Construction of a Quilt:

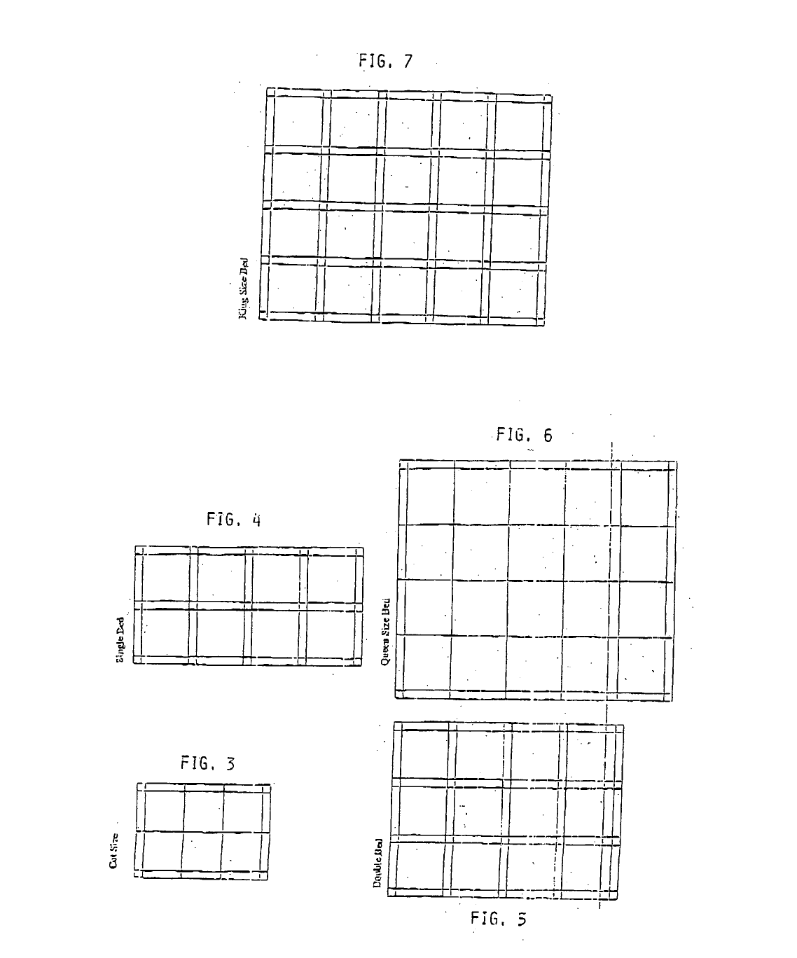

Determine the size of the quilt you wish to make. Diagrams in FIGS. 3 to 7 show the recommended structure for various bed sizes.
FIG. 3: Cot 2×3 squares plus 10 cm (4″) external borders
FIG. 4: Single 2×4 squares plus 10 cm (4″) external and internal Borders
FIG. 5: Double 3×4 squares plus 10 cm (4″) internal and external borders
FIG. 6: Queen 4×5 squares plus 10 cm (4″) external border
FIG. 7: King 4×5 squares plus 10 cm (4″) internal and external borders

It is to be understood that various alterations, modifications and/or additions may be made to the features of the possible and preferred embodiment(s) of the invention as herein described without departing from the scope of the invention as defined in the appended claims.

1. An applique pattern kit including a plurality of templates bearing identifying indicia and which can be arranged to correspond to a desired completed design, said templates being removably located on a support member, said support member having a location guide to assist in locating said templates in position on the support member.

2. An applique pattern kit according to claim 1 wherein the templates together bear the design of a complete applique item.

3. An applique pattern kit according to claim 1 wherein the location guide comprises an outline of each template marked on said support member.

4. An applique pattern kit according to claim 1 wherein said support member includes template retaining means.

5. An applique pattern kit according to claim 4 wherein the template returning means is a raised border around the periphery of the support member which abuts the templates.

6. A method of making an applique including the steps of:
providing a backing fabric;
providing a plurality of templates bearing identifying indicia and which can be arranged to correspond to a desired completed design, said templates being removably located on a support member, said support member having a location guide to assist in locating said templates in position on the support member;
removing the templates from the support member;
tracing a line around each template onto desired fabrics to give an outline of each template;
cutting around each outline optionally allow a seam allowance, to give pieces of fabric; and
attaching each piece of fabric to the backing fabric to create the desired completed design.

7. A method according to claim 6 wherein the templates together bear the design of a complete applique item.

8. A method according to claim 6 wherein the location guide comprises an outline of each template marked on said support member.

9. A method according to claim 1 wherein said support member includes template retaining means.

10. A method according to claim 9 wherein the template retaining means is a raised border around the periphery of the support member which abuts the templates.
